(19) United States
(12) Patent Application Publication
(10) Pub. No.: US 2014/0223295 A1
(43) Pub. Date: Aug. 7, 2014

(54) Geographic Based Spell Check

(71) Applicant: LSI CORPORATION, San Jose, CA (US)

(72) Inventors: Roger A. Fratti, Allentown, PA (US); James R. McDaniel, Allentown, PA (US)

(73) Assignee: LSI CORPORATION, San Jose, CA (US)

(21) Appl. No.: 13/762,073

(22) Filed: Feb. 7, 2013

(51) Int. Cl. G06F 17/27

(52) U.S. Cl. CPC G06F 17/273
USPC 715/257

(57) ABSTRACT

The present disclosure is directed to a method for spell checking. The method includes the step of generating a geographic based list of words. The method also includes the step of appending the geographic based list of words to a spell check list. A further step of the method includes detecting a change in position. The method also includes the step of generating a new geographic based list of words when a change in position occurs.

### BACKGROUND

Current spell checkers may not provide appropriate spelling for some words. For example, current spell checkers may not provide the appropriate spelling for geographic location names or other local or regional oddities.

Therefore, there exists a need for improved methods and systems for spell checking that provide appropriate spelling for words, including words across a wide range of geographic locations and languages.

### SUMMARY

The present disclosure is directed to a method for spell checking. The method includes the step of generating a geographic based list of words. The method also includes the step of appending the geographic based list of words to a spell check list. A further step of the method includes detecting a change in position. The method also includes the step of generating a new geographic based list of words when a change in position occurs.

The present disclosure is also directed to a system for geographic based spell checking. The system includes a location detection system configured to determine a position of the system and also to detect a change in position of the system. The system also includes a processor. The processor is in communication with the location detection system. The processor is configured to generate a spell check list and a geographic based list of words based on the position of the system. The processor is further configured to append the spell check list with the geographic based list of words. The processor is also configured to update the geographic based list of words when a change in position of the system occurs. The system also includes a memory. The memory is configured for storing a computer executable program code. The computer executable program code is configured to execute on the processor.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 shows a flow diagram of the steps for performing a method for spell checking;

FIG. 2 is a diagrammatic representation of a system for performing a geographic based spell check; and

FIG. 3 is a map in accordance with an example for using a system for performing a geographic based spell check.

### DETAILED DESCRIPTION

Current spell checkers may not provide appropriate spelling for some words. For example, if a user wishes to find a restaurant near a location such as Mohnton, Pa., misspells Mohnton, the results for the search may not include restaurants near Mohnton but instead may return results for another location or the search may return otherwise inaccurate results. Similarly, users traveling in foreign countries may not be able to accurately spell words in a foreign language and the existing spell checker may not be able to suggest correct spellings in other languages.

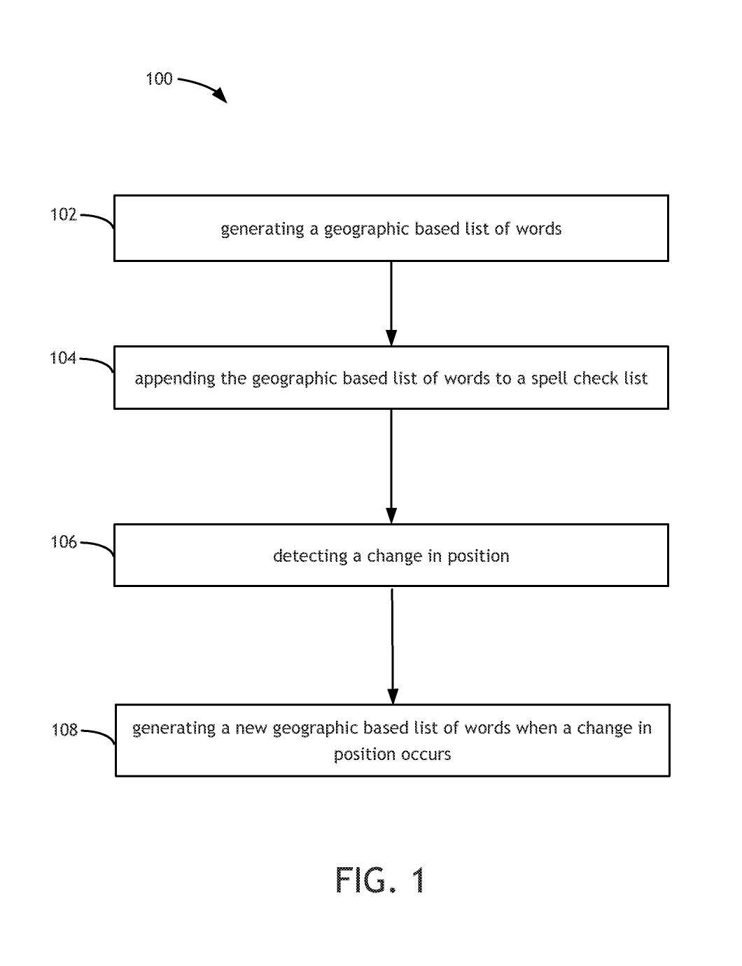

The present disclosure is directed to systems and methods for providing a geographic based spell check that takes into account the location of the user in providing suggested spellings. Reference will now be made in detail to the subject matter disclosed, which is illustrated in the accompanying drawings. Referring generally to FIG. 1, a method 100 for spell checking is provided. The method 100 includes the step of generating a geographic based list of words 102. The method 100 also includes the step of appending the geographic based list of words to a spell check list 104. A further step of the method 100 includes detecting a change in position 106. The method 100 also includes the step of generating a new geographic based list of words when a change in position occurs 108.

The method 100 includes the step of generating a geographic based list of words 102. In one embodiment, this step includes generating the geographic based list of words based on a current location of a user. In one embodiment, the geographic based list of words takes into account points of interest that are located near the user. Similarly, the geographic based list of words takes into account the country where the user is located and the primary language spoken in that country or part of that country when suggesting geographic based words to the user.

The step of generating a geographic based list of words 102 is also based on a user input in one embodiment. For example, if a user types in a word such as a nearby location, the step of generating the geographic based list of words will be based on the word provided by the user as well as the location of the user.

The method 100 provided in FIG. 1 also includes the step of appending the geographic based list of words to a spell check list 104. In one embodiment, this step includes appending the geographic based list of words to a spell check list generated by conventional systems and methods. The appended list including the geographic based list of words is seamlessly presented along with the spell check list in one embodiment. In another embodiment, the geographic based list of words is interspersed with at least some of the words from the conventional spell check list. In another embodiment, the appended list is kept separate from the spell check list. In yet another embodiment, some words from either the appended list or the spell check list are highlighted over other words.

The method 100 also includes the step of detecting a change in position 106 to include any or all of the following: crossing a geographic boundary, such as a river, mountain range, or body of water; crossing a political boundary, such as a border between countries or region; crossing a state boundary, a county line, a city limit, a change in a time zone, a change in altitude; or a change in distance. The forgoing list is not intended to be limiting and is merely exemplary, and the change in position may be correlated to any geographic, physical, or political boundary or other feature as may be desired. Similarly, the change in distance or the change in altitude required to constitute a change in position for purposes of the method 100 may vary. In one embodiment, a change in distance means a change of approximately one mile, such as a movement of one mile or more in any direction as compared to an original position of the user or the last detected position of the user. A change in altitude includes a change of 1,000 feet or more in one example. These examples are not intended to be limiting, and those skilled in the art will appreciate that it is possible to correlate the step of step of detecting a change in position 106 of the method 100 to any desired change in distance or altitude.

The step of detecting a change in position 106 of the method 100 shown in FIG. 1 is accomplished using a global positioning system in one embodiment. In another embodiment, the change in position is detected using an accelerometer. In another embodiment, the change in location is detected using a cellular or Wi-Fi network. Any other suitable system capable of detecting a change in position may also be used.

The method 100 shown in FIG. 1 is implemented by an application on a computing device in one embodiment. The application may include a range of applications, including a social networking application, a word processing application, a text messaging application, a navigation application, a travel application, a mapping application, or an e-reader application. The forgoing list is merely exemplary and the scope of applications on which the method 100 may be implemented is not intended to be limited to the examples described. Any application using a text function may implement the method 100. Similarly, the method 100 is implemented in conjunction with an existing spell checker program in one embodiment.

The method 100 shown in FIG. 1 is implemented by an application on a computing device in one embodiment. The computing device may include a cell phone, a laptop computer, a tablet computer, a personal computer, a PDA, an e-reading device, or a navigation system. The forgoing list is merely exemplary and the scope of devices on which the method 100 may be implemented is not intended to be limited to the examples described. Any device using a text function may implement the method 100.

An additional step of the method 100 shown in FIG. 1 includes receiving a selection of a word from the spell check list, the spell check list including the geographic based list of words in one embodiment. For example, in this step a user reviews the spell check list with the appended geographic based list of words, identifies the desired word, and selects the word. The system receives the user's selection of the desired word from the spell check list with the appended list.

In one embodiment, the method 100 is performed continuously. Specifically, the spell check list including the appended geographic based list of words is updated any time a change in position is detected. In one embodiment, the spell check list including the appended geographic based list is further appended with additional geographic based words when a change in position occurs. For example, some words are removed from the spell check list if a change in position is detected and the locations associated with those words are no longer nearby. Additional words may then be added as new locations are closer to the user.

The geographic based list of words of the method 100 includes words in languages other than the default language of the device implementing the method 100 in one embodiment. The geographic based list of words is generated based on the current position of the device, which detects the language spoken in the country or in a particular area of the country where the device is located in one embodiment. The geographic based list of words will change if the device crosses borders into another country. For example, if the change in position includes crossing a political boundary, such as moving from one country to another country where a different language is spoken, the change in position will trigger geographic based words in the language of the country where the device is currently located.

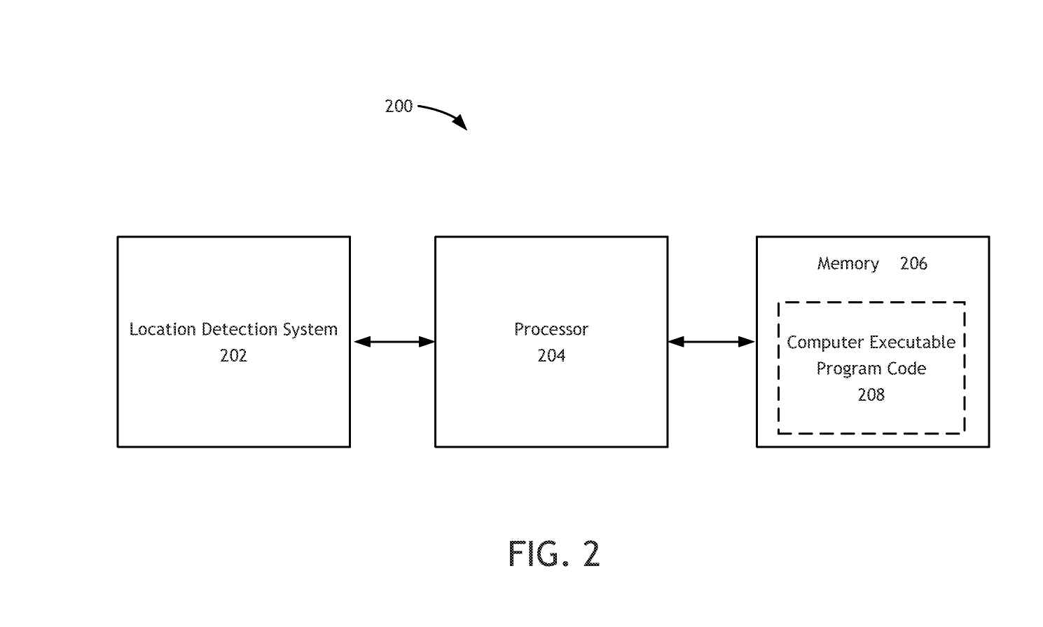

The present disclosure is also directed to a system 200 for geographic based spell checking, as shown in FIG. 2. The system 200 includes a location detection system 202. The location detection system 202 is configured to determine a position of the system 200 and also to detect a change in position of the system 200. The system 200 also includes a processor 204. The processor 204 is in communication with the location detection system 202. The processor 204 is configured to generate a spell check list and a geographic based list of words based on the position of the system 200. The processor 204 is further configured to append the spell check list with the geographic based list of words. The processor 204 is also configured to update the geographic based list of words when a change in position of the system 200 occurs. The system 200 also includes a memory 206. The memory 206 is configured for storing a computer executable program code 208. The computer executable program code 208 is configured to execute on the processor 204.

The location detection system 202 includes a global positioning system in one embodiment. In another embodiment, the location detection system 202 includes an accelerometer. In another embodiment, the location detection system 202 includes a cellular or Wi-Fi network. The location detection system 202 may also include any other suitable system capable of detecting a change in position (the change in position including any or all of: crossing a geographic boundary; crossing a political boundary; crossing a state boundary; a change in a time zone; a change in altitude; or a change in distance).

The processor 204 includes a suitable computer processor in one embodiment. The memory 206 is any system and/or device capable of storing data. In one embodiment, memory 206 stores computer executable program code 208 that, when executed by processor 204, causes processor 204 to perform a method for geographic based spell checking.

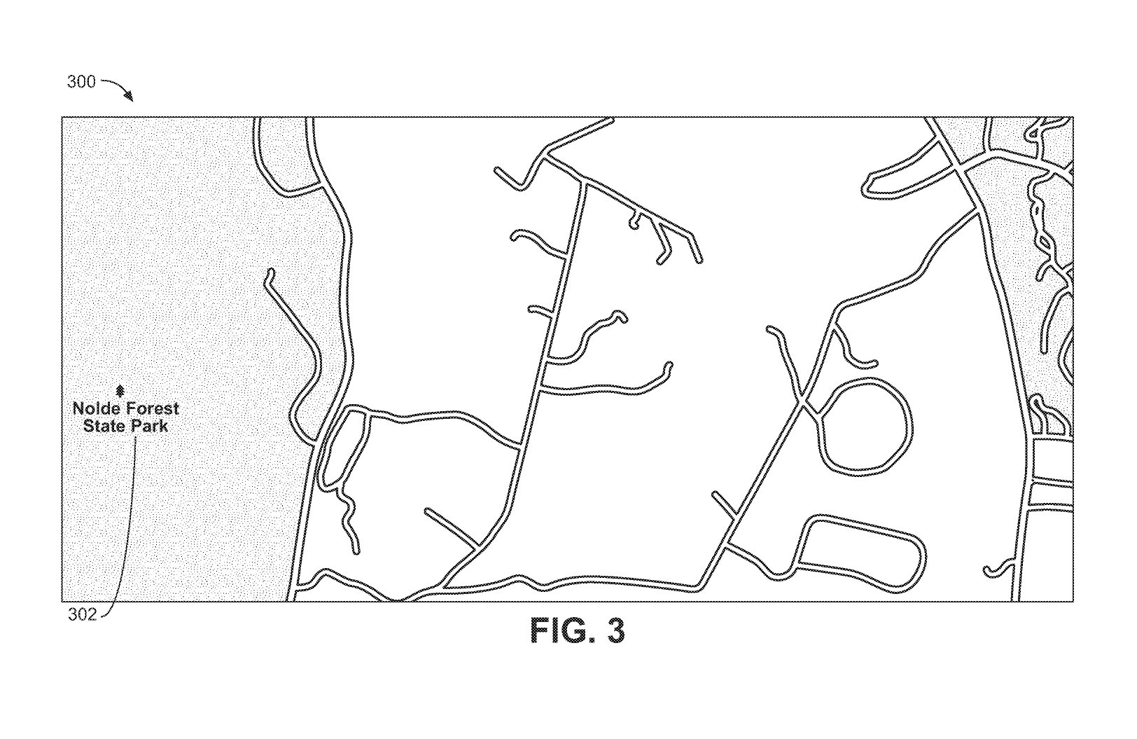

An example application of the system 200 and method 100 in accordance with the present disclosure is now described. In the example, a user may be traveling on Route 625 in Pennsylvania and come into range of Nolde Forest State Park 302, as shown in FIG. 3. The user wishes to send a text message that refers to the nearby Nolde Forest State Park 302. In the example, the user's cell phone includes the system 200, and the location detection system 202 in the user's cell phone detects the location of the user and the nearby point of interest, in this case, Nolde Forest State Park 302. When the user types the first few letters of Nolde Forest State Park (“No”), the spell checker or text prediction function on the user's phone suggests several different words, like Noodle, Nothing, Noone. Using the system 200, the system 200 detects the user's location and appends the spell check list with a geographic based list that includes Nolde Forest State Park. The user then selects the desired word from the appended spell check list in the text message.

In an additional example, a user may be using a smart phone to search for a nearby restaurant. In the example, the user is located in Mohnton, Pa. The user uses the internet to perform the search, for example, on a website that searches for restaurants near a location provided by the user. When inputting the location as requested by the website, the user begins to type in Mohnton but misspells Mohnton. The system 200 has detected the user's position and received the user input, and now provides an appended list of location based words, including the correct spelling for Mohnton. The user then selects the correct spelling of the city from the appended list.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The foregoing detailed description may include set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but may be not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Those having skill in the art will recognize that the state of the art may have progressed to the point where there may be little distinction left between hardware, software, and/or firmware implementations of aspects of systems; the use of hardware, software, and/or firmware may be generally (but not always, in that in certain contexts the choice between hardware and software may become significant) a design choice representing cost vs. efficiency tradeoffs. Those having skill in the art will appreciate that there may be various vehicles by which processes and/or systems and/or other technologies described herein may be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for a mainly hardware and/or firmware vehicle; alternatively, if flexibility may be paramount, the implementer may opt for a mainly software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and or firmware.

What is claimed is:

1. A method for spell checking, the method comprising:
generating a geographic based list of words;
appending the geographic based list of words to a spell check list;
detecting a change in position; and
generating a new geographic based list of words when a change in position occurs.

2. The method as claimed in claim 1, wherein the change in position includes at least one of: crossing a geographic boundary, crossing a political boundary, crossing a state boundary, a change in a time zone, a change in altitude, or a change in distance.

3. The method as claimed in claim 1, wherein the detecting a change in location includes detecting a change in location using at least one of: global positioning system, an accelerometer, a cellular network, or a Wi-Fi network.

4. The method as claimed in claim 1, wherein the generating a geographic based list of words includes generating a geographic based list of words based on at least one of: a user input and a geographic location of the user.

5. The method as claimed in claim 1, wherein the method is implemented by an application on a computing device.

6. The method as claimed in claim 5, wherein the application includes at least one of: a social networking application, a word processing application, a text messaging application, a navigation application, a travel application, a mapping application, or an e-reader application.

7. The method as claimed in claim 5, wherein the computing device includes at least one of a cell phone, a laptop computer, a tablet computer, a PDA, an e-reading device, or a navigation system.

8. The method as claimed in claim 1, further comprising:
receiving a selection of a word from the spell check list, the spell check list including the geographic based list of words.

9. A system for geographic-based spell checking, the system comprising:
a location detection system, the location detection system configured to determine a position of the system, the location detection system further configured to detect a change in position of the system;
a processor, the processor in communication with the location detection system, the processor configured to generate a spell check list, the processor further configured to generate a geographic based list of words based on the position of the system, the processor further configured to append the spell check list with the geographic based list of words, the processor further configured to update the geographic based list of words when a change in position of the system occurs; and
a memory, the memory configured for storing a computer executable program code, the computer executable program code configured to execute on the processor.

10. The system as claimed in claim 9, wherein the change in position includes at least one of: crossing a geographic boundary, crossing a political boundary, crossing a state boundary, a change in a time zone, a change in altitude, or a change in distance.

11. The system as claimed in claim 9, wherein the location detection system includes at least one of: global positioning system, an accelerometer, or a cellular network positioning system.

12. The system as claimed in claim 9, wherein the processor is configured to generate the geographic based list of words based on at least one of: a user input and a geographic location of the user.

13. The system as claimed in claim 9, wherein the system includes at least one of a cell phone, a laptop computer, a tablet computer, a PDA, an e-reading device, or a navigation system.

14. The system as claimed in claim 9, further comprising:
a user input system, the user input system in communication with the processor, the user input system configured for receiving a selection of a word from the spell check list, the spell check list including the geographic based list of words.

15. A computer-readable device having computer-executable instructions for performing a method for spell checking, the instructions comprising:
generating a geographic based list of words;
appending the geographic based list of words to a spell check list;
detecting a change in position; and
generating a new geographic based list of words when a change in position occurs.

16. The device as claimed in claim 15, wherein the change in position includes at least one of: crossing a geographic boundary, crossing a political boundary, crossing a state boundary, a change in a time zone, a change in altitude, or a change in distance.

17. The device as claimed in claim 15, wherein the detecting a change in location includes detecting a change in location using at least one of: a global positioning system, an accelerometer, a cellular network, or a Wi-Fi network.

18. The device as claimed in claim 15, wherein the generating a geographic based list of words includes generating a geographic based list of words based on at least one of: a user input and a geographic location of the user.

19. The device as claimed in claim 15, wherein the device includes at least one of a cell phone, a laptop computer, a tablet computer, a PDA, an e-reading device, or a navigation system.

20. The device as claimed in claim 15, wherein the instructions further comprise:
receiving a selection of a word from the spell check list, the spell check list including the geographic based list of words.
